(19) United States
(12) Patent Application Publication
(10) Pub. No.: US 2006/0044965 A1
(43) Pub. Date: Mar. 2, 2006

(54) Emergency recording on an information recording apparatus

(75) Inventor: Stuart Butterfield, Watlington (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/527,360

(22) PCT Filed: Aug. 29, 2003
(86) PCT No.: PCT/IB03/03964

§ 371 Date: Mar. 10, 2005

(30) Foreign Application Priority Data
Sep. 11, 2002 (GB) 0221030.0

(51) Int. Cl. G11B 19/02; G11B 21/08

(52) U.S. Cl. 369/47.1; 369/30.01; 369/59.1

(57) ABSTRACT

The invention comprises an information recording apparatus (1) incorporating a memory device (3) having a defined quantity of storage space, and an interface (2) for use by a user in initiating the recordal of data onto the memory device (3), wherein a selected portion of the storage space of the memory device is reserved for the recording of data in an emergency situation and the interface is configured such that instructions to record data to the selected portion of the memory device are effected by means separate from those used to initiate recordal of data in the remainder of the memory device.

The present invention relates to methods for recording of data on a digital recording device where storage space in the memory of that device is limited. The device may be, for example, a digital video recording apparatus.

It is known from GB 2 365 180 to prioritise data records historically stored in a memory of a digital information recording device (for example a camera) and to compress records according to their priority rating so as to provide sufficient space for the storage of a new record.

It is known from U.S. 2001/0006403 A1 to manage filing of data stored in a memory of a television receiving apparatus by firstly prioritising files and then reorganising them to create space for a new data item to be recorded. Files having a lower priority associated therewith may be deleted automatically to provide space for a new record.

Such arrangements typically require input from a user to assist in prioritising individual records and to authorise deletion of records. In some circumstances, it may not be convenient or even possible for the user to provide such input, yet the user may desire instantly to record a data item. Such a case may arise where a user sets a video recorder to record a live action TV broadcast and there is no time prior to the start of the broadcast to free space in the memory of the recording apparatus. Alternatively, the user may set his recording apparatus via a timer and may not be available when the recording is initiated to provide input on file reorganisation or deletion.

An object of the present invention is to provide an emergency recording facility which does not require the deletion or reorganisation of files already stored in a memory prior to recording of a new file.

According to a first aspect, the present invention provides an information recording apparatus incorporating a memory device having a defined quantity of storage space and an interface for use by a user in initiating the recordal of data onto the memory device, wherein a selected portion of the storage space of the memory device is reserved for the recording of data in an emergency situation and the interface is configured such that instructions to record data to the selected portion of the memory device are effected by means separate from those used to initiate recordal of data in the remainder of the memory device.

The information recording apparatus is, optionally, a digital video recording apparatus and may, but does not essentially, form part of a television broadcast receiving and viewing apparatus, for example apparatus commonly referred to as personal video recorders (PVRs). The invention may equally be extended to other information recording apparatus, for example music player/recorders, digital cameras, personal digital assistants (PDAs), personal computers (PCs) or digital telephones.

The interface may be of any conventional form, for example but without limitation, a remote control handset, a control panel provided on the body of the apparatus or an on screen menu display from which desired operations of the recording apparatus can be selected. The means for initiating recordal of a data item to the selected portion of the memory device may be embodied in the form of an emergency record button (which may be an icon provided on a screen display).

By reserving dedicated space in the memory of the apparatus, the user is always able to record a data item without sacrificing any data already stored in the remainder of the memory. The user then has the opportunity to reorganise/rationalise the data stored in the remainder of the memory to provide space for long-term storage of any data item stored in the selected portion of the memory device. The interface desirably further provides means for initiating transfer of data stored in the selected portion to an available location in the remainder of the memory device.

In a commercial embodiment of the invention, data stored in the selected portion of the memory device may optionally be encrypted or otherwise rendered inaccessible by, for example, the provider of the apparatus (or the memory device thereof) or the supplier of the recorded data. A decryption key (or other means for enabling access to the inaccessible recorded data) may be provided in return for payment of a fee.

Typically, the selected portion of the memory device is configured such that, in the absence of sufficient available storage space therein, previously recorded data will be overwritten so that the latest data designated for recordal in an emergency situation is always recorded.

The memory device may take any known form, for example a CD, DVD, mini-disc, digital tape, or a hard disk. The memory device may be contained within the apparatus itself or may be situated at a remote location, the apparatus incorporating telecommunication means facilitating the initiating of recordal of data to and the download of recorded data from the memory device.

The apparatus preferably includes a controller for managing storage and retrieval operations within the memory device. The controller optionally comprises a microprocessor programmed to perform certain operations including storage and retrieval of data. The controller may further be configured to carry out financial transactions between a user of the apparatus and a supplier of data to be recorded or a supplier of emergency memory in the selected portion of the memory device.

In another aspect, the invention provides a method for storing a defined data item in response to an emergency instruction comprising;
locating a selected portion of a memory device reserved for the storage of data items in an emergency situation;
downloading the defined data item from its source; and
recording the defined data item onto the selected portion.

Optionally, the method may further include a step of determining the space required for storing the defined data item, checking the space available in the selected portion and if the latter is less than the former, reorganising the pre-recorded data in the selected portion so as to provide the space required for storing the data item.

Optionally, the step of reorganising may include compressing pre-recorded data stored in the selected portion. Additionally, or in the alternative, the step of reorganising may include deleting or overwriting pre-recorded data.

In a further option, the method may include the step of encrypting the defined data item. Where the data item is encrypted, the method may further include a step of receiving authorisation for payment of a fee by the user of the apparatus and in response, decrypting the data item.

In an alternative, the method may include the step of receiving authorisation for payment of a fee by the user prior to the step of downloading the defined data item.

The controller of the apparatus may further be configured to intelligently handle instructions to record data items. For example, where instructions are provided to record data through means ordinarily used to initiate recordal of data in the remainder of the memory device, the controller may search for an appropriate amount of available space and if insufficient space is found, the controller may interpret the instruction as an instruction to record data to the selected portion of the device and proceed to carry out the aforementioned method.

In another aspect therefore, the invention provides a method for storing a defined data item in an information recording apparatus incorporating; a memory device having a defined quantity of storage space, and an interface for use by a user in initiating the recordal of data onto the memory device, and wherein a selected portion of the storage space of the memory device is reserved for the recording of data in an emergency situation, comprising;
determining the space required for storing the defined data item;
checking the space available in the remainder of the memory device and if the latter is less than the former;
locating a selected portion of the memory device;
downloading the defined data item from its source; and
recording the defined data item onto the selected portion.

Optionally, the method may further include, checking the space available in the selected portion and if the latter is less than the space required for recording the defined data item, reorganising the pre-recorded data in the selected portion so as to provide the space required for storing the data item.

Optionally, the step of reorganising may include compressing pre-recorded data stored in the selected portion. Additionally, or in the alternative, the step of reorganising may include deleting or overwriting pre-recorded data.

In a further option, the method may include the step of encrypting the defined data item. Where the data item is encrypted, the method may further include a step of receiving authorisation for payment of a fee by the user of the apparatus and in response, decrypting the data item.

For the purposes of exemplification some embodiments of the invention will now be further described with reference to the following Figures in which;

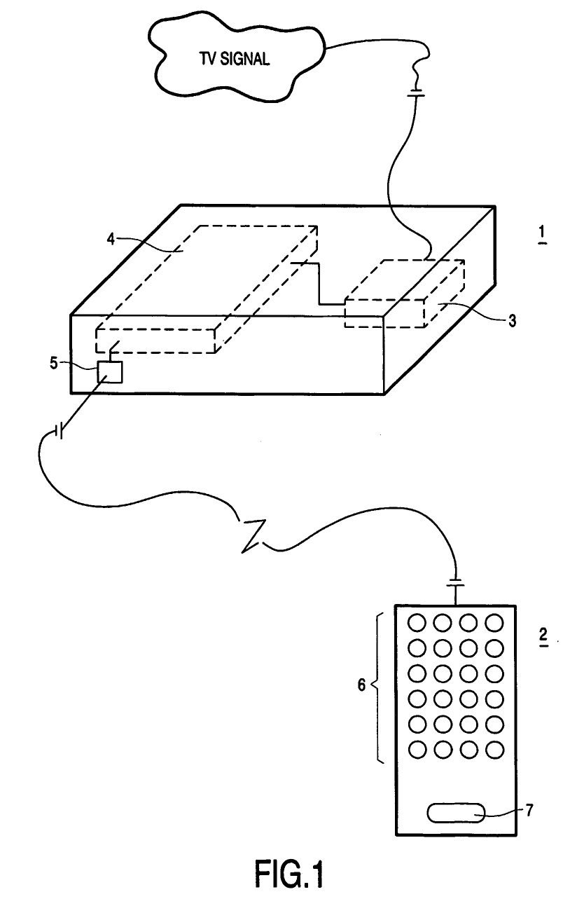

FIG. 1 shows schematically one embodiment of the apparatus of the invention, and

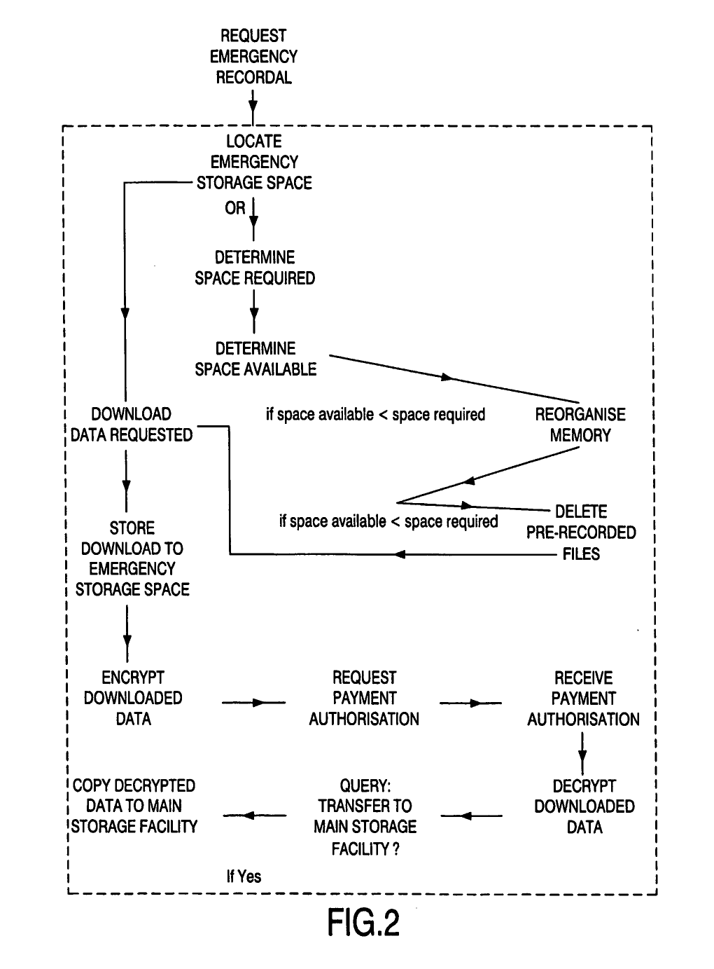

FIG. 2 shows diagrammatically the steps performed by an example of a method in accordance with the invention.

As can be seen from FIG. 1, one embodiment of the invention is provided in the form of a television set top box 1 of the type commonly used for providing services such as a TiVO™, ReplayTV™, or Open Source. The box 1 encloses a controller 4 and a hard disk 3 that provides memory storage space. An interface is provided in the form of a remote control handset 2 from which signals instructing the controller 4 are transmitted. The signals are received by a receiver 5 located on the box 1 and communicating with the controller 3.

The remote control handset has a main control panel 6 and a separately located button 7 for initiating the emergency record function. The normal record function can be effected through the main control panel 6.

Each button on the handset has associated with it a pre-programmed instruction to the controller 4. When the instruction is received, the requested operation is performed by the controller. In the embodiment shown, the handset 2 has two buttons for instructing the controller 4 to perform a record operation. One is located in the main control panel 6 of the handset 2 and the other is the emergency record button 7. The program associated with each of these buttons is configured to instruct the controller to record data only in a defined region of the hard disk 3. In the case of button 7, this defined region of the hard disk corresponds to the selected portion described hereinabove. In addition, the program associated with button 7 may include an instruction to overwrite pre-recorded data already stored in the selected portion if there is insufficient space available in it to store the requested data. In this particular embodiment, the data to be recorded will be a TV broadcast receivable by the box 1 and which can be downloaded to the hard disk 3 on request.

The method performed by a controller of an information recording address in accordance with the invention is summarised in the flow chart of FIG. 2. The steps carried by the controller are outlined by a broken line box.

As can be seen, on receipt of an instruction to record in an emergency, the controller locates the space in the memory device that is reserved for emergency recording. Having identified the data to be stored, the controller optionally determines the space required to store it and then searches the emergency storage facility for sufficient space to record the requested data. If insufficient space is found, a reorganising of pre-stored data is performed. If there remains insufficient space, the controller begins deleting pre-recorded data so as to create space. Once space is available, the data is downloaded and stored.

In a simpler, alternative embodiment, the data is downloaded directly and written over any pre-recorded data in the emergency storage facility. In the embodiment shown, the downloaded data is encrypted with a code not known to the user of the apparatus. When the user attempts to access the recorded data file, the controller generates a message to the user displayed via the interface, requesting authorisation to deduct payment from an account. Once authorisation is received and validated (using conventional means), the data is decrypted and can be accessed by the user. Additionally, in the particular example shown, the controller generates a message to the customer giving him an option to copy the data to the main memory of the apparatus for long term storage. If the response is in the positive, the decrypted file is copied to the main part of the memory device.

1. An information recording apparatus (1) incorporating; a memory device (3) having a defined quantity of storage space, and an interface (2) for use by a user in initiating the recordal of data onto the memory device (3), wherein a selected portion of the storage space of the memory device (3) is reserved for the recording of data in an emergency situation and the interface (2) is configured such that instructions to record data to the selected portion of the memory device (3) are effected by means separate from those used to initiate recordal of data in the remainder of the memory device.

2. An information recording apparatus as claimed in claim 1 wherein the information recording apparatus is a digital video recording apparatus.

3. An apparatus as claimed in claim 1 wherein the information recording apparatus is selected from a music player/recorder, a digital camera, personal digital assistant (PDA), a personal computer (PCs) or a digital telephone.

4. An information recording apparatus as claimed in claim 1, 2 or 3 wherein the interface is selected from; a remote control handset, a control panel provided on the body of the apparatus or an on screen menu display from which desired operations of the recording apparatus can be selected.

5. An information recording apparatus as claimed in any preceding claim wherein the means for initiating recordal of a data item to the selected portion of the memory device is embodied in the form of an emergency record button.

6. An information recording apparatus as claimed in claim 5 wherein the emergency record button is in the form of an icon provided on a screen display.

7. An information recording apparatus as claimed in any preceding claim further comprising an encoding device for encoding data to be stored in the selected portion.

8. An information recording apparatus as claimed in any preceding claim wherein the memory device consists of a CD, DVD, mini-disc, digital tape or a hard disk.

9. An information recording apparatus as claimed in any preceding claim wherein the apparatus includes a controller (4) for managing storage and retrieval operations within the memory device.

10. An information recording apparatus as claimed in claim 9 wherein the controller (4) comprises a microprocessor (4) programmed to perform certain operations including storage and retrieval of data.

11. An information recording apparatus as claimed in claim 9 or 10 wherein the controller (4) is configured to carry out financial transactions between a user of the apparatus and a supplier of data to be recorded, or a supplier of emergency memory in the selected portion of the memory device.

12. A method for storing a defined data item in an information recording apparatus according to any one of claims 1 to 11 comprising;
determining the space required for storing the defined data item;
checking the space available in the remainder of the memory device and if the latter is less than the former;
locating a selected portion of the memory device;
downloading the defined data item from its source; and
recording the defined data item onto the selected portion.

13. A method as claimed in claim 12 further comprising;
checking the space available in the selected portion and if the latter is less than the space required for recording the defined data item, reorganising the pre-recorded data in the selected portion so as to provide the space required for storing the data item.

14. A method as claimed in claim 13 wherein the step of reorganising include compressing pre-recorded data stored in the selected portion.

15. A method as claimed in claim 13 or 14 wherein the step of reorganising includes deleting or overwriting pre-recorded data.

16. A method as claimed in any of claims 12 to 15 further comprising
a step of encrypting the defined data item.

17. A method as claimed in claim 16 further comprising a step of receiving authorisation for payment of a fee by the user of the apparatus and in response, decrypting the data item.
